(19) United States
(12) Patent Application Publication
(10) Pub. No.: US 2010/0274527 A1
(43) Pub. Date: Oct. 28, 2010

(54) Timer for simultaneously cooking multiple steaks to differing doneness

(76) Inventors: Greg Ruff, Spokane, WA (US); Jeff Bendio, Spokane, WA (US); Leon Schmidt, Spokane, WA (US)

Correspondence Address: LUKINS & ANNIS, 717 WEST SPRAGUE AVE., SUITE 1600, SPOKANE, WA, 99201, US

(21) Appl. No.: 12/386,769

(22) Filed: Apr. 24, 2009

(51) Int. Cl. G04F 10/00; G06F 15/00; G04G 9/00; G04G 13/00

(52) U.S. Cl. 702/178; 368/109

(57) ABSTRACT

A cooking timer having a microprocessor, a transistor, a display driver, a power source, plural user input buttons and alerts electrically interconnected with a visual display for selecting and displaying data for simultaneously cooking plural steaks with varying physical characteristics to differing doneness levels and ensuring all of the steaks finish cooking to the desired doneness levels at the same time.

### BACKGROUND OF INVENTION

1. Related Applications

There are no applications related hereto heretofore filed in the United States of America or in any foreign country.

2. Field of Invention

This invention relates to horology, and more particularly to an electronic timer that allows a user to simultaneously cook plural steaks having differing thicknesses to differing doneness levels and having the multiple steaks finish cooking at the same time.

3. Background and Description of Prior Art

For purposes of this patent application, the term “cook” shall include barbecuing and broiling using cooking appliances such as gas barbecues, charcoal barbecues, electric barbecues, gas ovens, electric ovens and the like. The term “steak” is used generically and is not limited to beef products, but may also refer to a variety of food items including pork, mutton, poultry, venison, fish, buffalo, shellfish, vegetables and the like.

Cooking a great steak is as much of an art as it is a science. Unfortunately, most people are not sufficiently versed in the art of cooking nor in the science of cooking to simultaneously cook multiple steaks having varying physical characteristics to differing degrees of doneness and have the steaks finish cooking and ready to eat at the same time.

For example a first diner wants a 1¾ inch thick steak cooked to medium rare, a second diner wants a ¾ inch steak cooked to medium, a third diner wants a steak 1½ inch thick steak cooked to medium well and a fourth diner wants a 1 inch thick steak cooked rare. If all four steaks were to be cooked to the same doneness level each would have different cook times. Indeed, even if all four steaks had the same thickness they would still have different cook times.

A common solution to this problem is to cook all of the steaks for the same amount of time and remove all of the steaks from the grill one at the same time. Unfortunately, this satisfies no one.

Another common solution is to remove the steaks from the grill at different times when each steak has reached its approximate desired doneness level. This often results in some diners finishing their meal before others are even served. Again, this solution satisfies no one.

What is needed is a timer that allows a user to simultaneously cook plural steaks of differing thicknesses to differing doneness levels and ensure the steaks are cooked to the desired doneness level and finish cooking at the same time, so that the diners may eat together. Such a timer necessarily works in reverse by fixing a single end time, and then calculating an amount of time prior to the end time where various events must occur for each steak to achieve the desired doneness level at the end time.

Various cooking tools and aids are known that use probes to sense internal temperatures and moisture content to determine doneness. Cooking timers are also known, but are typically for single food items, or plural food items having the same physical characteristics being cooked to the same doneness level. Such cooking timers also track the cooking time from a “begin” time as opposed to from a single “end” time. Cooking timers and tools having audible user alerts are also available. Unfortunately, when plural steaks, each having differing cooking characteristics (i.e. thickness and desired doneness level) are cooked simultaneously, known cooking timer devices still require the user to separately calculate and coordinate the necessary/required cook times for each individual steak to ensure that the steaks finish cooking at the same time. Such coordination is difficult if not impossible.

Known timing methods and timing apparatus are relatively effective when a single steak or food item is being cooked, or when plural steaks, each with the same physical characteristics, are cooked to the same doneness level. However, when each steak has different thicknesses and various of the steaks are to be cooked to differing doneness levels, known timers are not adequate.

Prior art does not disclose a timer device that calculates the necessary cook times for plural steaks, each steak having individual characteristics and desired doneness levels, to ensure all of the steaks complete cooking, to the user selected doneness level, at the same time so that the diners may dine together.

Our invention overcomes various shortcomings of prior art devices by providing a small programmable electronic timing device a user may position proximate a cooking appliance that simultaneously calculates cook times and event times for cooking plural steaks to ensure all the steaks complete cooking at the same time. Depending upon the type of cooking appliance used, the operator makes a selection between a grill and a broiler. The operator also makes a selection between “ALL” and “EACH”. Selection of the “ALL” option causes the timing to apply to all the steaks, in which case all of the steaks finish cooking at the same time. The operator may alternatively select the “EACH” option wherein the timer calculates and tracks the event times for each steak individually, in which case the steaks may finish cooking at different times. In both instances, the timing begins when the timer start button is depressed.

Options for steak thickness are: ¾ inch, 1.0 inch, 1¼ inch, 1½ inch and 1¾ inch which are the most common steak thicknesses. Steaks having thicknesses greater than or less than these parameters are uncommon and are more readily cooked with expertise and instruments not common with amateur cooks.

Options for doneness levels are: “R” Rare, “MR” Medium-Rare, “M” Medium, “MW” Medium-Well and “W” Well.

The operator selects, for each row displayed on the screen, the thickness of each steak and the desired doneness for each steak. Movement amongst the various fields and selection of the desired inputs is accomplished with user input buttons adjacent the screen.

The desired inputs are made for each steak, and then the “start” button is activated.

Our invention calculates the necessary cooking time and event times for each steak individually and provides the operator with alerts “GO”, “XXX”, “FLIP”, “XXX” and “END” and accompanies each alert with an audible alert and a visual alert. The “XXX” symbol indicates the steak should be rotated 45 degrees about a vertical axis to form an aesthetically pleasing cross-hatch grill pattern on the steak.

The steak requiring the longest cooking time, taking into account the thickness and the desired doneness, is placed on the cooking appliance first. The user thereafter is provided with a “GO” instruction for each of the remaining steaks which are placed on the cooking surface in order, from maximum cooking time to minimum cooking time, when the timer provides the “GO” alert for that particular steak.

Our invention does not reside in any single one of the identified features individually but rather in the synergistic combination of all of its structures, which give rise to the functions necessarily flowing therefrom as hereinafter claimed.

### SUMMARY

A cooking timer having a microprocessor, a transistor, a display driver, a power source, plural user input buttons and alerts electrically interconnected with a visual display for selecting and displaying data for simultaneously cooking plural steaks with varying physical characteristics to differing doneness levels and ensuring all of the steaks finish cooking to the desired doneness levels at the same time.

In providing such a timing device for simultaneously cooking plural steaks to differing doneness levels and having the steaks finish cooking at the same time, it is:

a principal object to address and overcome shortcomings of known cooking timer devices.

a further object to provide a cooking timer device that simultaneously tracks plural different cooking times for plural steaks.

a further object to provide a timing device that ensures a plurality of steaks being simultaneously cooked finish cooking to various desired doneness levels at the same time.

a further object to provide a timing device that provides an alert for various events for each steak individually.

a further object to provide a timing device that allows a user to select a steak thickness.

a further object to provide a timing device that allows a user to select a desired doneness level.

a further object to provide a timing device that provides the cook with an audible alert when an action is due to be taken for each steak.

a further object to provide a timing device that provides the cook with a visual alert when an action is due to be taken for each steak.

a further object to provide a timing device that determines a single end time and alters the start time and event times for each steak relative to the end time.

a still further object to provide rugged portable timing device adapted for use in indoor and outdoor cooking settings.

Other and further objects of our invention will appear from the following specification and accompanying drawings which form a part hereof. In carrying out the objects of our invention it is to be understood that its structures and features are susceptible to change in design and arrangement with only one preferred and practical embodiment of the best known mode being illustrated in the accompanying drawings and specified as is required.

### BRIEF DESCRIPTIONS OF DRAWINGS

In the accompanying drawings which form a part hereof and wherein like numbers refer to similar parts throughout:

FIG. 1 is an isometric front, top and second side view of the cooking timer device.

FIG. 2 is an isometric rear, bottom and first side view of the cooking timer device.

FIG. 3 is an orthographic top view thereof.

FIG. 4 is an orthographic bottom view thereof.

FIG. 5 is an orthographic first side view thereof.

FIG. 6 is an orthographic second side view thereof.

FIG. 7 is a schematic diagram of the circuitry of the cooking timer device.

FIG. 8 is a diagrammatic representation of the LCD screen showing the various fields.

### DESCRIPTION OF PREFERRED EMBODIMENT

Our timing device 9 provides a durable housing 10, printed circuit board (not shown), liquid crystal display (LCD) 22, liquid crystal display driver 24, speaker 25, transistor 26, microprocessor 29, plural user input buttons 30, 31, 32, 33, 34 and power source 27.

The power source 27 is preferably two 1.5 volt AA batteries; although it is contemplated other power sources 27 such as a 9 volt battery may likewise be utilized. Any necessary modifications to the circuitry to accommodate a change of powering source 27 are obvious to routiners in the art.

The durable housing 10 has a front portion 11, a rear portion 12, a top portion 13, a bottom portion 14, a first side portion 15 and a second side portion 16. The housing 10 is preferably formed of a durable plastic such as high-density polyethylene, or ABS plastic to prevent damage if the timing device 9 is dropped or the like. In its preferred form, the dimensions of the timing device 9 are approximately 4½ inches wide, approximately 3¼ inches high and approximately 1¼ inches deep so that the timing device 9 is portable and easily stored when not in use.

The rear portion 12 of the timing device 9 defines a battery compartment (not shown) having a removable battery compartment cover 20 and a steak thickness gauge 48 proximate first side portion 15 and bottom portion 14. The steak thickness gauge 48 preferably ranges from 0 to 2 inches in ¼ inch increments with the bottom portion 14 of the durable housing 10 representing 0 thickness measurement. The steak thickness gauge 48 allows a user to place a steak on a flat surface, and then place the timing device 9 on the same flat surface with the rear 12 of the timing device 9 adjacent the steak and the bottom portion 14 on the flat surface. The steak thickness gauge 48 allows a user to accurately determine the thickness of a steak which is a required user input. Although not illustrated, the steak thickness gauge 48 may be in other units of measurement, such as centimeters. The durable housing 10 may also carry a hinged stand (not shown) so that the timing device 9 is self-supporting in an orientation that increases visibility during use.

The front portion 11 of the timing device 9 reveals screen 23 of the LCD 22 which is preferably a low energy consuming transflective LCD, or its equivalent, that maximizes readability in ambient light conditions but is also translucent to permit backlighting with light emitting diodes (LED's) 51. The front portion 11 also has plural spacedly arrayed user input buttons 30, 31, 32, 33, 34 in a vertical column proximate the second side portion 16.

As shown in FIG. 8, LCD screen 23 defines five vertically spaced horizontal rows 35, 36, 37, 38, 39 of user selectable parameters 40, 41, 42, 43, 44, 45, user action alerts 46 and time remaining data 47.

Active row indicator 49, proximate left side portion of the screen 23 is “arrow head” shaped and indicates the row 35, 36, 37, 38, 39 which is active for parameter selection. Active field 53 designates the particular parameter that is active and may be selected by the user pressing Select button 31. Active field 53 is visually identifiable because it flashes on and off repeatedly.

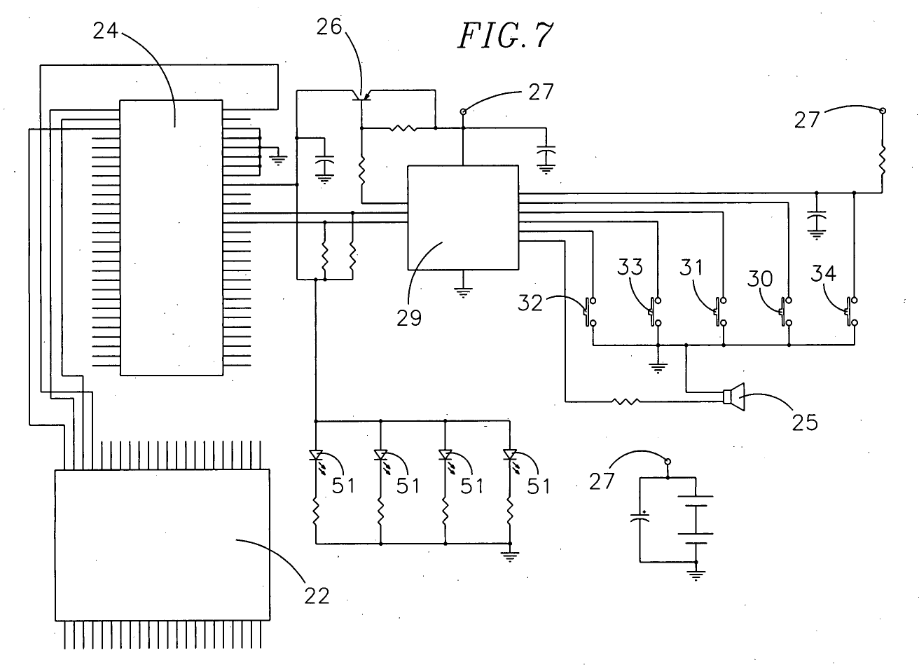

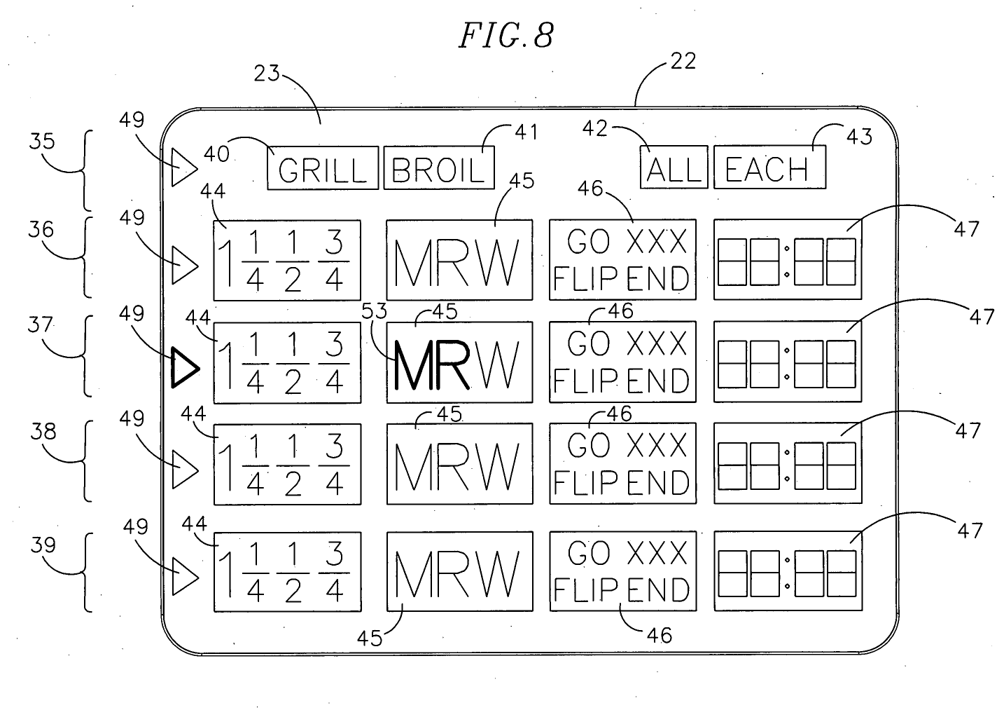

LCD screen 23 is illuminated with plural LED's 51 carried by a printed circuit board (not shown) proximate the LCD 22. In the preferred embodiment the LED's 51 are red, green or yellow in color because red, green and yellow LED's 51 may be powered with two 1.5 volt AA batteries as a power source 27. Various other color LED's 51 such as blue or white LED's require a higher voltage power source 27, such as a 9 volt battery which necessitates use of a regulator (not shown), or the like to reduce the voltage flowing through the microprocessor 29 and related circuitry. (FIG. 7). Modifications necessary to use blue and white LED's 51 are obvious to routiners in the art. In the preferred embodiment, the LED's 51 remain continuously illuminated while the timing device 9 is active.

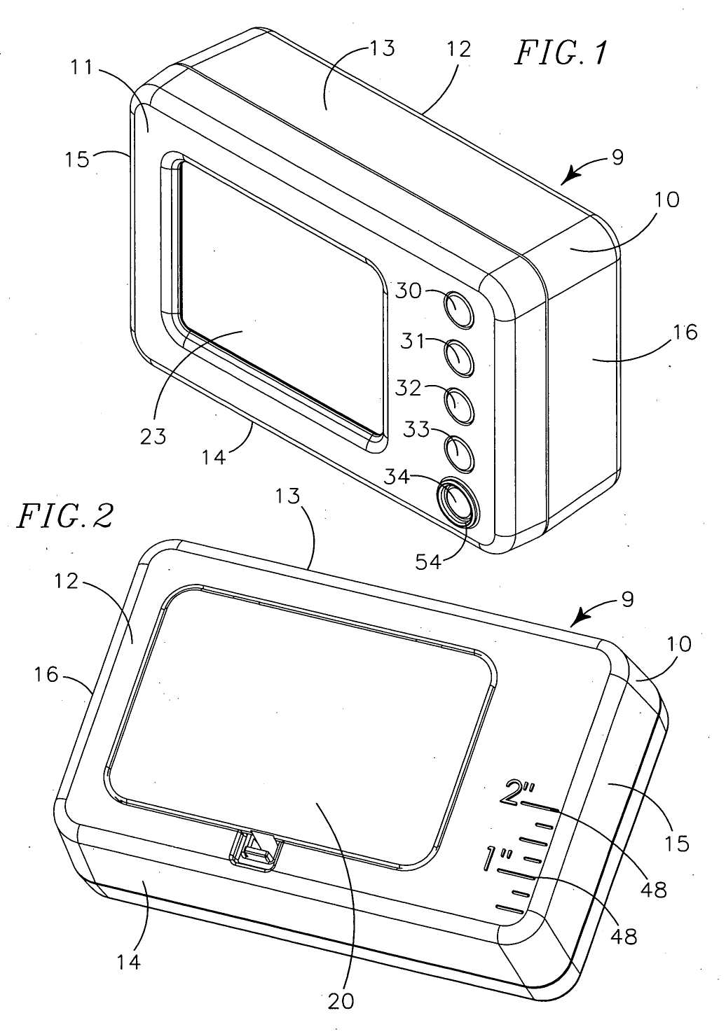

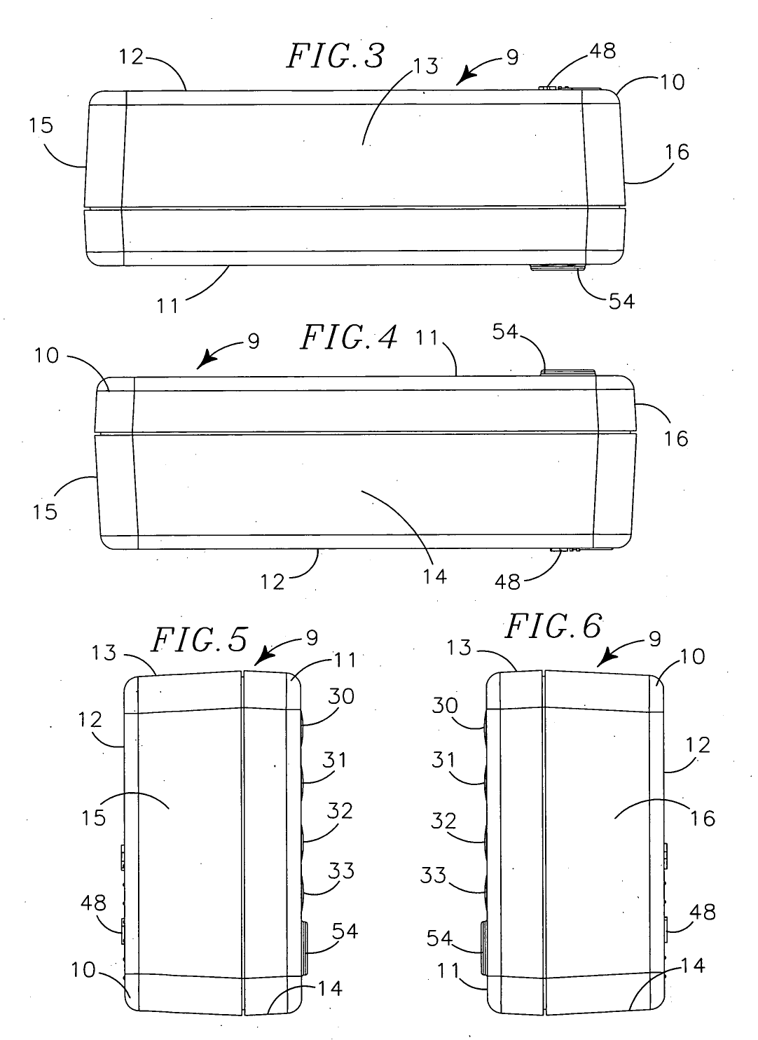

User input button 34 (FIG. 1) is a multi function switch that operates as a “POWER ON” switch, which actuates the circuitry and brings the timing device 9 into an active mode, and also as a “CLEAR’ button. The clear function clears the user inputted data in the row 35, 36, 37, 38, 39 identified by the active row indicator 49. If user input button 34 is depressed to clear the row 35, 36, 37, 38, 39, the user must re-select the input data for that particular row 35, 36, 37, 38, 39. Protruding annular ring 53 surrounds user input button 34 to prevent the button 34 from being inadvertently pressed during use which would “clear” the ongoing timing functions.

User input button 31 functions as a select button allowing the user to select a desired parameter 40, 41, 42, 43, 44, 45. The parameter 40, 41, 42, 43, 44, 45 that is active, and may be selected by depressing input button 31, is visually identifiable because it flashes on and off repeatedly.

User input button 32 functions as a right movement button which moves the flashing active field 53 to the right in that particular row 35, 36, 37, 38, 39.

User input button 33 functions as a down movement button which moves active row indicator 49 and the active field 53 vertically downward to the next row. Pressing user input button 33 while the active row indicator 49 is on line 39 (the bottom row) causes the active row indicator 49 and the active field 53 to revert back to row 35.

User input button 30 functions as a start button which is used to initiate the timing sequence after the user parameters 40, 41, 42, 43, 44, 45 have been selected.

As shown in FIG. 8, line 35 which is uppermost row of LCD screen 23 provides for user's selection of parameters “GRILL” 40, or “BROIL” 41 and for user's selection of parameters “ALL” 42 or “EACH” 43. Selection of the “ALL” 42 field causes the timing device 9 to coordinate the timing in rows 36, 37, 38, 39 to ensure all of the rows 36, 37, 38, 39, and the steaks represented thereby, reach their desired doneness level 45 at the same END time wherein all of the rows 36, 37, 38, 39 receive an END alert and audible alert at the same time. Alternatively, selection of the “EACH” 43 field causes the timing device 9 to individually determine the actions and END time for each row 36, 37, 38, 39 separately. Use of the EACH 43 selection makes the timing device 9 function as plural individual cooking timers wherein each row 36, 37, 38, 39 has its own steak cooking timer and the various steaks finish cooking at different times.

Rows 36, 37, 38 and 39 are spacedly below line 35 and are vertically spaced apart from one another. Each row 36, 37, 38 and 39 has, from left to right, a steak thickness field 44, a steak doneness field 45, an action field 46 and a time remaining field 47. Rows 36, 37, 38 and 39 may represent individual steaks, although if plural steaks have the same physical characteristics (i.e. thickness) and desired doneness level, (e.g. Medium-Rare) those plural steaks may be represented by the same row 36, 37, 38, 39.

Steak thickness field 44 allows the user to input the thickness of the steak that will be represented by that particular row 36, 37, 38, 39. The steak thickness field 44 options are ¾ inch, 1 inch, 1¼ inch, 1½ inch and 1¾ inch. User navigates through the steak thickness options by using user input button 32 which moves the flashing active field 53 to the right. When the appropriate steak thickness is flashing, the user selects that thickness by pressing select button 31. The user then navigates to the steak doneness field 45 using navigation button 32 which moves the flashing active field 53 to the right. The options presented in the steak doneness field 45 are “R” representing Rare, “MR” representing Medium-Rare, “M” representing Medium, “MW” representing Medium-Well and “W” representing Well done. The user similarly navigates through the steak doneness 45 options by using navigation button 32. When the desired doneness level 45 is flashing, the user selects that doneness level 45 by pressing the select button 31. In FIG. 8, the MR steak doneness selection 45 in row 36 is bolded to visually represent the active field 53 which would flash on and off repeatedly. Similarly the active row indicator 49 is likewise bolded to represent that row 36 as the active row.

Navigation button 33 is used to move the flashing active field 53 and the active row indicator 49 to the next row 37, 38, 39 down. The process is repeated for rows 36, 37, 38, 39 as desired.

Action field 46, which is between the steak doneness field 45 and the time remaining field 47, comprises four separate user alerts that are actuated and made visible on the LED screen 23 at the appropriate time dependent upon the input in the steak thickness field 44, the input in the steak doneness field 45, and the time remaining field 47. The user alerts in the action field 46 are: “GO”, “XXX”, “FLIP” and “END”. The “GO” indicator is actuated and made visible when the user should begin cooking the steak represented by that particular row 36, 37, 38, 39. The “XXX” indicator is actuated and made visible when the user should rotate the subject steak 45° about a vertical axis to create an aesthetically pleasing cross-hatch pattern on the steak. The “FLIP” indicator is actuated and made visible when a user should flip/turn the steak so that second side (not shown) of the steak is exposed to the cooking heat. The “XXX” indicator will again be actuated and made visible when it is appropriate to rotate the steak 45° about a vertical axis to create the aesthetically pleasing cross-hatch pattern on the second side of the steak. The “END” indicator is actuated and made visible when the steak has reached the desired doneness level at which time the time remaining field 47 will show 00:00. In the preferred embodiment all action field 46 alerts cause the action field 46 to flash on and off repeatedly and an audible alert via speaker 25 is sounded. As presently contemplated, the action field 46 and the audible alert will simultaneously flash and annunciate respectively for a period of approximately 10 seconds which provides adequate time for a user to identify the steak needing an action and for the action to be completed.

Time remaining field 47 displays, in digital format, the time remaining for the steak represented by that particular row 36, 37, 38, 39 in minutes and seconds until the cooking is complete. The time remaining field 47 counts downwardly, in one second intervals, from the GO event to the END event.

If the “ALL” field 42 is selected prior to the timing function being activated all of the time remaining fields 47 will reach 00:00 at the same time. Alternatively, if the EACH field 43 is selected, each row 36, 37, 38, 39 counts down to an END event without regard to the time remaining for any of the other rows 36, 37, 38, 39.

FIG. 7 illustrates schematically the electronic circuitry of the illustrated embodiment of the present invention. Microprocessor 29 is preferably a C8051T605 chip manufactured by Silicon Laboratories Inc. All of the functional features of the timing device 9 are connected directly or indirectly to the microprocessor 29 which is mounted on a printed circuit board (not shown). These features include a transflective LCD 22, LCD driver 24, illuminating LED's 51 for the LCD 22 and LCD screen 23, audible alarm 25 which is preferably a piezo-electric speaker, the start button 30, the select button 31, the right movement button 32, the down movement button 33 and the clear button 34 as well as other functions of the timing device 9 including the user settable selections and the power source 27.

The LCD 22 is a custom liquid crystal display having four backplanes (not shown) for displaying user selectable parameters 40, 41, 42, 43, 44 and 45, user alerts 46 and time remaining 47.

The liquid crystal display driver 24 generates all of the signals (not shown) necessary to power and update the four backplanes (not shown) of the LCD 22. The liquid crystal display driver 24 is preferably a PCF8576 DT manufactured by Phillips Semiconductor, Inc. Signals generated by the liquid crystal display driver 24 communicate with the LCD 22 via known circuitry.

The microprocessor 29 and the liquid crystal display driver 24 communicate with one another through known circuitry.

User input buttons 30, 31, 32, 33, 34 are interconnected with known pushbutton switches SW1, SW2, SW3, SW4 and SW5 respectively, carried by the printed circuit board (not shown) to provide user input to the microprocessor 29 to select the user parameters for each row 35, 36, 37, 38, 39.

The microprocessor 29 generates signals (not shown) which are communicated with the liquid display driver 24 and thereafter to the LCD 22 to actuate the user alerts 46 and the speaker 25 and to cause the time remaining field 47 to count down the remaining time.

The speaker 25 is preferably a piezo electric speaker capable of generating multiple musical tones dependent upon the signal received from the microprocessor 29.

The transistor 26 interrupts the flow of electrical current to the liquid crystal display driver 24 when the timing device has been powered off. The powered off state occurs automatically when the timing device 9 has been inactive for a period of approximately 10 minutes and no user input has been made using user input buttons 30, 31, 32, 33, 34.

Having described the structure of our timer for simultaneously cooking plural steaks to differing doneness levels its operation may be understood.

The cooking appliance (not shown) such as a grill or broiler is set to high heat. Although the high heat setting of cooking appliances may vary from appliance to appliance, the timing formulas embedded in the microprocessor 29 are based upon a cooking temperature in the 400-500 degrees Fahrenheit range which is most commonly attained at the high heat setting, or when the charcoal briquettes are red-hot. For purposes of this description it is assumed the user is cooking on a propane barbeque grill and that the user wants all of the steaks to complete cooking at the same time.

The steaks to be cooked are placed on a flat surface (not shown), and the steak thickness gauge 48 is used to accurately determine the thickness of each steak by placing the bottom portion 14 of the timing device 9 on the flat surface and comparing each steak to the steak thickness gauge 48. The steaks are sorted by thickness. The user next determines, the desired doneness level each diner desires for their steak.

If multiple steaks have the same thickness and are to be cooked to the same doneness, those multiple steaks may be represented by the same row 36, 37, 38, 39 and be cooked simultaneously. The user needs to treat each of such multiple steaks the same and apply all of the events to each one of the multiple steaks.

The user grasps the timing device 9 and presses the POWER ON user input button 34 which brings the timing device into an active mode and illuminates the LED's 51.

User input buttons 32 and 33 are used to maneuver the active row indicator 49 and the active field 53 to uppermost row 35 and to the GRILL 40 or BROILER 41 field. The user moves the active field 53 to the GRILL 40 field which flashes on and off repeatedly. The user presses the Select user input button 31 to select the GRILL option. User then presses the right movement user input button 32 to move the active field 53 to the next field to the right. The user presses the select button 31 to select ALL once the ALL field 42 begins flashing on and off. The user next presses the down movement user input button 33 which responsively moves the active row indicator 49 and the active field 53 to row 36.

Right movement user input button 32 is used to move the active field 53 through the options presented in the steak thickness field 44 which are ¾, 1, 1¼, 1½, and 1¾ representing the thickness of the steak to be represented by row 36. Once the appropriate thickness of the steak begins flashing, the user presses the select user input button 31 to select that parameter and presses the right user input button 32 again to move the active field 53 to the steak doneness field 45. The right movement user input button 32 is used to move the active field 53 though the options presented in the steak doneness 45 field which are “R” representing Rare, “MR” representing Medium-Rare, “M” representing Medium, “MW” representing Medium-Well and “W” representing Well done. Once the desired doneness level begins flashing, the user presses the select user input button 31 to select that parameter. The timing device automatically calculates the cook time for the steak represented by row 36 and the cook time is displayed in the time remaining field 47 as a digital numerical number.

The user next presses the down movement user input button 33 which responsively moves the active row indicator 49 and the active field 53 to row 37 wherein the process of inputting the steak thickness data 44 and steak doneness level 45 is inputted on row 37 in the same process as noted above. The process is repeated for rows 38 and 39 as desired.

After the timing device 9 has been programmed, as described above, the user presses the start user input button 30 which begins the timing operation.

The row 36, 37, 38, 39 representing the steak requiring the longest cooking time receives a flashing GO alert in the action field 46 and an audible alert is sounded as the timing device 9 sends an electrical signal to the speaker 25. After the GO alert is actuated, the time represented in the time remaining field 47 begins counting down toward 00:00.

Sometime after the row 36, 37, 38, 39 representing the steak requiring the longest cooking time receives the GO alert, the timing device actuates the next user alert in the action field 46, which may be a GO alert for another row 36, 37, 38, 39 or some other alert such as XXX on the row 36, 37, 38, 39 that has already received the GO alert.

The timing device 9 coordinates the cooking times for all rows 36, 37, 38, and 39 so that all of the END alerts are actuated in the action fields 46 at the same time. All alerts in the action field 46, other than the GO alert which directly correlates to the END alert, are independent of all the other rows 36, 37, 38, 39.

Timing for the action field 46 alerts are pre-determined by the programming of the microprocessor 29.

Example: Three diners want to dine together. First diner wants a 1¾ inch thick steak cooked rare. Second diner wants a 1¼ inch thick steak cooked medium-rare and third diner wants a ¾ inch thick steak cooked medium-rare. The timing device 9 is programmed by the user selecting the appropriate parameters in the GRILL field 40 and the ALL field 42. Row 36 is programmed with 1¾ for the steak thickness field 44 and R in the steak doneness field 45 which generates a cook time of 12:00 in the time remaining field 47.

Row 37 is programmed with 1¼ for the steak thickness field 44 and MR in the steak doneness field 45 which generates a cook time of 10:30 in the time remaining field 47.

Row 38 is programmed with ¾ for the steak thickness field 44 and MR in the steak doneness field 45 which generates a cook time of 7:00 in the time remaining field 47.

The start user input button 30 is pressed and a GO alert is actuated and begins flashing in the action field 46 on row 36 at which time the 1¾ inch thick steak is placed on the grill. Simultaneously with the GO alert flashing the audible alert is sounded and the time remaining field begins counting downward from 12:00 toward 00:00.

When the time remaining field 47 on row 36 reaches 10:30, a GO alert is actuated and begins flashing in the action field 46 on row 37 at which time the 1¼ inch thick steak represented by row 37 should be placed on the grill. Simultaneously, the time remaining field 47 on row 37 begins counting downward from 10:30 toward 00:00 synchronously with the time remaining field 47 of row 36.

When the time remaining field 47 of row 36 reaches 8:30 an XXX alert is actuated and begins flashing in the action field 36 on row 36 and the audible alert is sounded indicating the 1¾ inch thick steak represented by row 36 should be rotated 45 degrees to create the cross-hatch grill pattern.

When the time remaining field 47 of row 37 reaches 7:30 an XXX alert is actuated and begins flashing in the action field 46 on row 37 and the audible alert is sounded indicating the 1¼ inch thick steak represented by row 37 should be rotated 45 degrees to create the cross-hatch grill pattern.

When the time remaining field 47 on row 36 reaches 7:00, a GO alert is actuated and begins flashing in the action field 46 on row 38 at which time the ¾ inch thick steak represented by row 38 should be placed on the grill. Simultaneously, the time remaining field 47 on row 38 begins counting downward from 7:00 toward 00:00 synchronously with the time remaining fields 47 of rows 36 and 37.

When the time remaining field 47 of row 36 reaches 5:00 a FLIP alert is actuated and begins flashing in the action field 46 on row 36 and the audible alert is sounded indicating the 1¾ inch thick steak represented by row 36 should be flipped so the second side of the steak is exposed to the cooking heat.

When the time remaining field 47 of row 38 reaches 4:50 an XXX alert is actuated and begins flashing in the action field 46 on row 38 and the audible alert is sounded indicating the ¾ inch thick steak represented by row 38 should be rotated 45 degrees to create the cross-hatch grill pattern.

When the time remaining field 47 of row 37 reaches 4:30 a FLIP alert is actuated and begins flashing in the action field 46 on row 37 and the audible alert is sounded indicating the 1¼ inch thick steak represented by row 37 should be flipped so the second side of the steak is exposed to the cooking heat.

When the time remaining field 47 of rows 36 and 37 reach 2:30 an XXX alert is actuated and begins flashing in the action field 46 for both rows 36 and 37 and the audible alert is sounded indicating the steaks represented by rows 36 and 37 should be rotated 45 degrees to create the cross-hatch grill pattern on the second sides. Simultaneously with the XXX alerts for rows 36 and 37, a FLIP alert is actuated in the action field 46 for row 38 indicating the steak represented by line 38 should be flipped so the second side of the steak is subject to the cooking heat.

When the time remaining field 47 of row 38 reaches 1:15 an XXX alert is actuated and begins flashing in the action field 46 on row 38 and the audible alert is sounded indicating the ¾ inch thick steak represented by row 38 should be rotated 45 degrees to create the cross-hatch grill pattern on the second side.

All of the time remaining fields 47 for rows 36, 37 and 38 reach 00:00 at the same time at which time the END alert is actuated and begins flashing in the action field 46 and the audible alert is sounded indicating all of the steaks have reached their desired doneness level and should be removed from the grill.

The foregoing description of our invention is necessarily of a detailed nature so that a specific embodiment of a best mode may be set forth as is required, but it is to be understood that various modifications of details, and rearrangement, substitution and multiplication of parts may be resorted to without departing from its spirit, essence or scope.

Having thusly described our invention, what we desire to protect by Letters Patent, and

What we claim is:

1. A timing device for simultaneously cooking groups of food items having varying characteristics to different doneness levels, with a cooking appliance, with the food items attaining the doneness levels at the same predetermined time, the timing device comprising in combination:
a housing carrying;
a microprocessor that has plural input buttons to receive input and generate output signals to a visual display, and
data storage of cooking time information; and
microprocessor means to sort and organize the cooking information to determine cooking times so all of the food items attain the doneness level at the same predetermined time; and,
means for powering the device.

2. The cooking timer device of claim 1 wherein:
the food items are steaks.

3. The cooking timer device of claim 1 wherein:
the powering means is two 1.5 volt AA batteries.

4. The cooking timer device of claim 1 wherein:
the powering means is a 9 volt battery.

5. The cooking timer device of claim 1 further comprising:
plural event time alerts communicated to a user

6. The cooking timer device of claim 1 further comprising:
an audible alert.

7. The cooking timer device of claim 1 further comprising:
a visual alert.

8. The cooking timer device of claim 1 further comprising:
a visual display driver communicating between the microprocessor and the visual display.

9. The cooking timer device of claim 1 further comprising:
a means for lighting the visual display.

10. The cooking timer device of claim 9 wherein:
the means for lighting the visual display comprises light emitting diodes.

11. A method for determining the cooking of steaks having varying characteristics to different doneness levels, wherein the steaks attain the different doneness levels at the same predetermined time using the device of claim 1, comprising the steps of:
classifying each steak according to the characteristics;
classifying each steak to the doneness level;
inputting the characteristics and doneness level for each steak into the device; and
activating the device to determine a variable starting time for each steak.
